(19) United States
(12) Patent Application Publication
(10) Pub. No.: US 2026/0242136 A1
(43) Pub. Date: Aug. 20, 2026

(54) MULTI-LEVEL STORAGE SYSTEM

(71) Applicant: AUTOSTORE TECHNOLOGY AS, Nedre Vats (NO)

(72) Inventors: Trond Austrheim, Etne (NO); Ingvar Fagerland, Kolnes (NO)

(21) Appl. No.: 19/489,497

(22) PCT Filed: Jun. 13, 2024
(86) PCT No.: PCT/EP2024/066491

§ 371 Date: Dec. 2, 2025

(30) Foreign Application Priority Data
Jun. 30, 2023 (NO) 20230740

(51) Int. Cl. B65G 1/04

(52) U.S. Cl. CPC B65G 1/0464; B65G 1/0478; B65G 1/0492

(57) ABSTRACT

A storage system comprises a first and a second grid structure of first or second storage columns, each storage column being arranged to accommodate a vertical stack of storage containers, a plurality of upright floor support components, an intermediate floor comprising a floor panel, and a plurality of container handling vehicles The grid structures each comprise a rail system having two perpendicularly arranged sets of parallel rails, wherein the storage columns of the grid structures are arranged beneath the associated rail system. The container handling vehicles are configured to move on the rail systems of the grid structures. The upright floor support components and the floor panel form a support framework on a ground with the intermediate floor in a selected vertical position on the upright floor support components, wherein the first grid structure is arranged beneath the intermediate floor and wherein the second grid structure is arranged on the intermediate floor.

### FIELD

The present disclosure relates to a multi-level storage system having a first grid structure and a second grid structure, as well as a method of creating a multi-level storage system.

### BACKGROUND

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 2010, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 2010, 301b,301c,401b,401c can be lifted and lowered, so that the first set of wheels 201b,301b,401b and/or the second set of wheels 2010,3010,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. In addition to storage columns 105, there are special-purpose columns within the framework structure. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. Note that the term ‘tilted’ means transportation of storage containers 106 having a general transportation orientation somewhere between horizontal and vertical.

For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2014/075937 A1 shows a storage system with two grid structures above each other and separated by a solid mezzanine. A lift connects both grids and is capable of transporting storage containers from one of the grid to the other. The creation of such a storage system is complex and cost-intensive, wherein the first and second grid structures are arranged on separate floors or mezzanines in a building.

### SUMMARY

The present invention is set forth and characterized in the independent claims, while the dependent claims describe optional features of the invention.

In one example, the present disclosure provides a multi-level storage system, comprising a first grid structure of first storage columns, each first storage column being arranged to accommodate a stack of storage containers, a second grid structure of second storage columns, each second storage column being arranged to accommodate a stack of storage containers, a plurality of upright floor support components, an intermediate floor comprising a floor panel, and a plurality of container handling vehicles for handling storage containers, wherein the first grid structure and the second grid structure each comprise an associated rail system having a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid columns, each comprising a grid opening defined by a pair of neighboring rails of the first set of rails and a pair of neighboring rails of the second set of rails, wherein the storage columns of the first and second grid structure are arranged beneath the associated rail system, wherein a first plurality of container handling vehicles are configured to move on the rail system of the first grid structure and a second plurality of container handling vehicles are configured to move on the rail system of the second grid structure, wherein the upright floor support components and the floor panel are configured to form a support framework extending from a base floor with the intermediate floor arranged at a vertical distance from the base floor by supporting the floor panel using the upright floor support components, wherein the first grid structure is arranged beneath the intermediate floor and wherein the second grid structure is arranged on the intermediate floor.

Thus, the storage system of the example comprises two or more grid structures. Each of the grid structures may constitute an automated storage and retrieval system. In the following, the two or more grid structures are referred to as “first grid structure” and “second grid structure” to distinguish them from each other. The first grid structure is arranged on a base floor (e.g. a base floor forming part of a structure housing the storage system), e.g. on a floor (for example, a ground floor) of an industrial hall, a warehouse or the like. The base could be the ground floor, but may also be a higher floor, such as a first floor or a second floor, etc. The storage system may be housed within a structure, such as a building, and the structure may comprise one or more floors, e.g. a ground floor. The second grid structure is arranged on the intermediate floor, where the intermediate floor is supported by the upright floor support components. The term “intermediate floor” is in reference to the position between the first grid structure and the second grid structure. The second grid structure may be placed directly on the intermediate floor. It may also be arranged indirectly on the intermediate floor, i.e. on a part or a plurality of parts arranged on the intermediate floor. Accordingly, the intermediate floor does not form part of the structure housing the storage system (e.g. the industrial hall or warehouse). Both grid structures may be substantially the same, i.e. they are preferably similarly designed.

The storage system may comprise a plurality of first grid structures and/or a plurality of second grid structures. In the latter case, the second grid structures may be arranged on the same intermediate floor, but may be spaced apart horizontally. However, they may also be arranged on two different intermediate floors, wherein the first grid structure may be arranged beneath both intermediate floors. The first grid structure and the second grid structure do not necessarily have the same size.

Both grid structures comprise a rail system as explained previously. Thus, in each of the grid structures, a first set of parallel rails and a second set of parallel rails form an individual grid pattern in the horizontal plane comprising a plurality of adjacent grid columns, each comprising a grid opening defined by a pair of neighboring rails of the first set of rails and a pair of neighboring rails of the second set of rails. Beneath each rail system, the storage columns are arranged. Each grid structure may be capable of storing and retrieving storage containers independent from the other(s).

The storage containers used in the storage system may comprise outer dimensions, i.e. width, length, and height, that correspond to the dimensions of common storage containers used in grid-based automated storage and retrieval systems. The interior dimensions may be e.g. 600×400 mm (length×width) and may have various heights, for example 200 mm, 310 mm, or 400 mm. The storage containers may comprise a top rim that completely surrounds a top opening. The top rim may comprise several apertures or openings for receiving or passing through gripping devices of a lifting frame of a remotely operated vehicle. The top opening allows items to be placed into the interior space or to be removed therefrom.

The storage containers may be configured to receive other storage containers stacked onto their top rim. The storage containers may have a certain structural stability, which allows to bear a certain maximum weight. This maximum weight corresponds to a maximum number of storage containers being loaded with a maximum design weight each. The maximum design weight may exemplarily be about 30 kg. If common storage containers for grid-based storage systems are used, the height of stacks in the first grid structure may be limited to about 5 to 6 m. To better utilize an available height inside an industrial hall or a warehouse for storing items, the storage system according to the disclosure provides at least one intermediate floor for supporting a second grid structure. The second grid structure may at least partially be fastened to the intermediate floor.

The intermediate floor can be flexibly and quickly formed, extended, or removed and does not require floors that are part of the structure housing the storage system, e.g. solid mezzanine floors. Thus, the storage system according to the disclosure is cost-efficient and yet advantageous.

The plurality of upright floor support components may be placed on a base floor forming part of a structure housing the storage system (for example, a ground floor of an industrial hall or warehouse), such that they stand in an upright manner on the base floor and extend above the first grid structure. The number of upright floor support components may be chosen depending on the available space and the desired size of the storage system. The upright floor support components may preferably be arranged in a regular pattern to form a horizontal arrangement of one or more rows to carry one or more floor panels.

The upright floor support components may be arranged in several rows on the base floor. In each of the rows the upright floor support components are preferably arranged in the same plane and in a distance to each other, preferably in an equidistant manner. The rows may be arranged at a distance to each other on the floor. As a result, a matrix-like arrangement of upright floor support components is formed.

The support framework may surround the first grid structure. It may protrude through some of the columns of the first grid structure. If two or more second grid structures are used, it may protrude through some of the columns of the second grid structure. Neighboring upright floor support components may be fixed together with additional elements. The support framework may be independent from the first grid structure and/or the second grid structure. The vertical distance between the base floor and the intermediate floor may be set at a height to accommodate the first grid structure beneath the intermediate floor.

The upright floor support components may comprise one or more connection members arranged at one or more vertical positions of the upright floor support components. A vertical position may be defined as a location on the respective upright floor support component at a certain distance from an end of the upright floor support component which is on the base floor, when measuring along a main extension axis of the support component (e.g. vertically upwards). A connection member or a support device (discussed in more detail below) may be configured to receive or carry a floor panel.

The floor panel may be a flat component that can be carried by the upright floor support components. Preferably, it has a rectangular shape (optionally a square shape) with two pairs of parallel edges. The pairs of parallel edges may be of equal or differing lengths. For supporting the floor panel on two or more upright floor support components, the floor panel may comprise one or more holding elements that are configured to engage with an upright floor support component directly or through a connection member or a support device. However, the floor panel may simply be laid onto a connection member or a support device, which may comprise a support beam as explained further below. For forming an intermediate floor, a plurality of floor panels may be coupled with a plurality of upright floor support components, wherein the floor panels then extend perpendicularly to the main extension axis of the upright floor support components and parallel to the base floor, on which the upright floor support components stand. That is, the intermediate floor may be horizontal. If the floor panel has a rectangular shape, a long side of the floor panel may extend along the main extension faces of the upright support components. However, also the short side may extend along the main extension faces of the upright support components.

The upright floor support components may extend through the rail system of at least the first grid structure, i.e. the upright floor support components extend through at least some of the columns of the first grid structure. This may allow to use standardized components, and it is not necessary to design components specifically for integration into a storage grid that do not extend through any of the columns. For example, pallet racking components with dimension intervals that deviate from the dimension intervals of the grid structures may be used. Hence, remotely operated vehicles (e.g. container handling vehicles) of at least the first grid structure may need to avoid contact with the upright floor support components by moving around them. In a control system that is configured to control operation of the remotely operated vehicles, obstacles in the form of upright floor support components may be defined. Planned paths for the remotely operated vehicles may avoid these defined obstacles.

One or more (for example, all) of the upright floor support components may take the form of a planar truss. The planar truss may form a traverse that predominantly extends in two dimensions. It may preferably span a substantially rectangular area and has a first direction of extension and a second direction of extension. The first direction of extension is intended to run in a vertical direction from the base floor in the installed state of the storage system. It thus defines the height of the upright floor support component when standing on the base floor. The second direction of extension is perpendicular thereto and thus defines a width of the planar truss. A thickness extension of the upright floor support component, i.e. the direction of extension of the planar truss perpendicular to the first direction and the second direction of extension, may depend on the required mechanical characteristics as well as the chosen material. The framework structure provides a certain dimensional stability of the upright floor support component. It may be chosen to comprise a sufficiently high rigidity and a sufficiently high area moment of inertia, leading to the ability of tolerating vertical loads of the second grid structure as well as to minimize deflections under loads in any other direction. The planar truss may comprise two upright frame profiles, and a plurality of diagonal braces. In addition, it may comprise a plurality of perpendicular (horizontal) struts. The braces and struts may be connected to the upright frame profiles through bolts or welding. However, the upright floor support components may also be manufactured as a single, integrally manufactured part.

The upright floor support components may comprise a metal material. Preferably, the metal material comprises steel, which may include roll-formed steel and structural steel. Preferably, it may comprise galvanized steel having a zinc coating that is highly resistant to shock and abrasion and has a sufficient resistance to oxidation and deterioration.

One or more of the upright floor support components may comprise a pallet racking frame. Pallet racking is known as a material handling storage aid system for storing materials on pallets. There are several types of pallet rackings. However, all types allow palleted materials to be stored in horizontal rows on multiple levels. It is usually necessary to use forklift trucks to place the loaded pallets on the racks for storage. The pallet racking systems usually comprise load beams, upright frames, i.e., the pallet rack frames, pallet supports and deckings. The pallet racking frame may preferably correspond to adjustable pallet racking structures and may exemplarily fulfil the principles for structural design according to EN 15512. This is particularly advantageous as standardized parts can be used to set up a support framework. The design of the storage system according to at least preferred examples of the disclosure substantially does not require any special components that need to be manufactured and stored to be able to provide the support framework-commercially available pallet racking frames can be used.

The storage system may comprise a plurality of support devices attachable to the upright floor support components, wherein the floor panel is couplable with the support devices. The floor panel may be installed by coupling it with at least two of the upright floor support components to form an intermediate floor. A support device may be capable of being connected to both an upright floor support component and the floor panel. The support device may be connected to the floor panel through a releasable connection, such as using nuts and bolts or the like. However, the support device may also be attached to the floor panel. If the floor panel has a stiffening structure, the support device may be attached to the stiffening structure. Depending on the material of the floor panel or the optional stiffening structure, the support device may be attached to the floor panel through welding, gluing, or the use of a screwing device or the like. The support device may also be an integral part of the floor panel. By using a combination of upright floor support components, floor panels and support devices, the support framework can be created.

The support device may comprise a support bracket. A support bracket may be an angular bracket. It may comprise two plates arranged at a right angle to each other, such that one plate can be placed on a vertical edge of an upright floor support component, and the other can project horizontally therefrom. The plates may have a rectangular shape, wherein a longer side of the plate is intended to extend in a vertical direction along the upright floor support component. The support bracket may comprise a shape that corresponds to the shape of a part of the upright floor support component, to which it is attached. One or both of the plates may comprise connecting elements that are connectable to connection members on the upright floor support component. For example, one of the plates may comprise protrusions or indentations/blind holes as connecting elements, which can be engaged with indentations/blind holes or protrusions as connection members on the upright floor support component. For example, the support bracket may comprise locking pins that protrude into a region, in which the right angle is defined, wherein the locking pins are configured to engage complementary holes on the upright floor support component. The length of the support bracket may determine the number of connecting elements, which in turn may determine the load that can be carried by the support bracket.

On a side facing away from the upright floor support component, the support bracket may be connectable to or connected with a support beam by having a flange, an insert, or any other suitable element that is configured to receive an end of the support beam.

The support device may comprise a support beam configured to extend perpendicularly to the upright floor support component to which the support device is coupled. The support beam may extend between two upright floor support components. Preferably, the support beam may extend perpendicularly to the main extension planes of the upright floor support components when it is attached, i.e. preferably, the support beam extends horizontally. A pair of support beams may be arranged between a pair of upright floor support components in order to support a floor panel. The support beams may be made from a metal material. They may comprise a cross-sectional profile that is suitable for supporting a floor panel, on which stacks of a second grid structure are placed. For example, the cross-sectional profile may comprise a rectangle, a T, a double T, an inverted U and the like. The support beam may be configured to extend along a longer side of the floor panel.

Preferably, a support beam or a plurality of support beams may be arranged between each pair of directly opposed main faces of upright floor support components. For example, if the upright floor support components are arranged in several rows on the base floor to form a matrix-like arrangement of upright floor support components, as explained above, support beams may be arranged between opposed upright floor support components perpendicularly to the extension of the rows and parallel to the base floor. A floor panel may extend over a plurality of consecutive support beams along a plurality of pairs of directly opposed main faces of upright floor support components. The floor panel may then bridge a distance between a consecutive pair of upright floor support components.

Floor panels may extend from one support beam of a pair of support beams to a support beam of a consecutive pair of support beams. Thus, a plurality of floor panels may be arranged in an end-to-end manner between pairs of upright support components.

The support beam may be rigidly attached to the support bracket. A support beam may be attached to two support brackets at its opposite ends. Two support beams that are connected to a pair of upright floor support components may be used to support a floor panel. The distance between the upright floor support components may thus be determined by the combination of support brackets and support beams. The rigid attachment of the support beam to the support bracket increases the stiffness of the framework structure.

The floor panel may comprise a stiffening structure. The floor panel may comprise a plate-shaped panel, which has a flat top side, on which a part of the second grid structure is to be placed. An underside of the floor panel may comprise an arrangement of support components, which provide additional support of the floor panel. The support components may be made from steel. They may be attached to the underside of the floor panel. The support components may be connected to each other to form a floor panel framework. The stiffening structure may be configured to be connectable to a support device mentioned further above. The stiffening structure may comprise the support beam described above. The stiffening structure may also comprise the support brackets described above.

The storage system may comprise a depth support strut arranged beneath the floor panel for supporting the floor panel. The storage system may comprise support beams as mentioned further above. Two support beams may be associated with each pair of upright support components. Both support beams may be arranged at a distance and parallel to each other. One or more depth support struts may be arranged between the two support beams. Preferably, two or more depth support struts are provided between the pair of support beams. The depth support strut may be fixedly attached to the support beam. If the floor panel has a stiffening structure, the depth support strut may optionally be a part of the stiffening structure.

The upright floor support components may have a base plate configured to be anchored to the base floor. Each upright floor support component may comprise a floor section which may comprise a base plate or the like to rigidly attach the upright floor support component to the base floor. The support framework is thus fixedly placeable on the ground. Besides preventing inadvertent movement, the stiffness of the support framework is increased by anchoring the upright floor support component to the base floor. For anchoring, the base floor may comprise drill holes, in which ground anchors, e.g. pallet racking anchor bolts, may be placed. The ground anchors may pass through the base plates of the upright floor support components.

The second grid structure may have a smaller height than the first grid structure. If the upright floor support components and the floor panel are provided by standardized components, e.g. pallet rack frames and a suitable floor panel, the support framework may have a certain load limit determined by the components used for the support framework. The load may depend on the distance between the upright floor support components, the length of the floor panel, as well as the number of second grids placed on the support framework. For example, the tolerable load may be comparable to a maximum bay load for a section of the intermediate floor between two upright floor support components. The tolerable weight for such a bay may be about 3 to 5 tons, for example.

The storage system may comprise a plurality of floor panels, wherein each floor panel is coupled with at least one pair of upright floor support components. The plurality of floor panels create the intermediate floor. Depending on the required size of the intermediate floor for supporting the second grid structure, and depending on the handleable size of floor panels, the number of floor panels can be chosen. It is conceivable to use floor panels that can be carried by more than one pair of upright floor support components. A pair of support beams may be arranged between the pair of upright floor support components to carry the floor panels.

The floor panel may comprise a particle board. A particle board may be coupled with the support beams by using clips, which may be referred to as Z sheets, and which may be distributed along the extension of the support beam. The clips may be connected to both the floor panel and the support beam. This may be achieved by a positive or non-positive connection.

In an alternative embodiment, the floor panel may comprise a steel panel. It may comprise bent edges that may reach around an outer edge of a support beam to further support the floor panel.

Adjacent floor panels may be connected to each other to avoid creation or enlargement of gaps between the floor panels. This may be achieved by clips or bands attached to edge regions of the respective floor panels.

As an alternative or in addition, a cover strip may be placed upon abutting edges of the floor panels.

The floor panels may have a rectangular footprint with a pair of parallel long sides and a pair of parallel short sides, and wherein at least the long sides of the floor panels may be coupled with one upright floor support component.

The rail system of the second grid structure may comprise a rail system extension that extends beyond the second storage cells and the intermediate floor to form a delivery section, wherein the delivery section may be arranged vertically directly above the first grid structure, such that container handling vehicles on the rail system of the second grid structure are capable of retrieving storage containers from or lowering storage containers into the first grid structure. It is advantageous to place upright members between the delivery section and the rail system of the first storage grid structure. Consequently, storage containers from one of the grid structures can be transferred to another one of the grid structures through moving a vehicle on the second grid structure to the delivery section extension and lowering or lifting a storage container. It may be feasible that the container handling vehicles may be capable to raise/lower storage containers about a greater distance than in a standard system.

The delivery section may extend along at least one side of the second grid structure. The delivery section may, however, also extend along two or more sides of the second grid structure. By providing a wide delivery section or multiple delivery sections, multiple vehicles may simultaneously transfer storage containers from one grid structure to another one. If multiple second grid structures are provided (e.g. one above another), storage containers may also be transferred between two directly vertically adjacent second grid structures.

Underneath the delivery section, upright members for guiding the storage containers to be transferred may be placed. These may be part of the first grid structure. They may be connected to the rail system and/or the support framework, as they cannot be placed onto the intermediate floor. However, the intermediate floor may have dedicated openings or cutouts to allow storage containers to pass through, wherein the upright members stand on the intermediate floor adjacent to the openings or cutouts.

The storage containers may be transferred from one of the storage grid structures to another one of the storage grid structures through an external conveyor or a lift system, which is often referred to as “bin lift system”. Such a system is exemplarily described in WO 2014/075937 A1 or WO 2019/238659 A2.

In a second example, to the present disclosure provides a method of creating a storage system according to the above, the method comprising providing a first grid structure of first storage columns, each first storage column being arranged to accommodate a vertical stack of storage containers, on a base floor, arranging a plurality of upright floor support components on the base floor and coupling a floor panel with the upright floor support components at a selected vertical position to form a support framework on the ground with an intermediate floor arranged at a vertical distance to the base floor, and providing a second grid structure of second storage columns, each second storage column being arranged to accommodate a vertical stack of storage containers, on the intermediate floor, wherein the first grid structure and the second grid structure each comprise a rail system having a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, each comprising a grid opening defined by a pair of neighboring rails of the first set of rails and a pair of neighboring rails of the second set of rails, the rail system being configured to let remotely operated vehicle (for example, container handling vehicles) operate on it.

The method may provide a storage system according to the first aspect, optionally including any of the optional features thereof.

### BRIEF DESCRIPTION OF THE DRAWINGS

Following drawings are appended to facilitate the understanding of the disclosure. The drawings show examples of the disclosure, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5a shows a storage system in the process of being assembled in a perspective view.

FIG. 5b shows a floor panel.

FIG. 5c shows a floor panel held by two upright floor support components in a top view.

FIG. 6 shows the storage system in a perspective view.

FIG. 7 shows the storage system having three second grid structures in a perspective view.

FIG. 8 shows the storage system having three second grid structures in a side view.

FIG. 9 shows a storage system having three second grid structures in a perspective view.

FIG. 10 shows the storage system of FIG. 9 in a perspective view.

FIGS. 11a and 11b show two top views of floor panels arranged on upright floor support components.

### DETAILED DESCRIPTION

In the following, examples of the disclosure will be discussed in more detail with reference to the appended drawings. It should be understood, however, that the drawings are not intended to limit the disclosure to the subject-matter depicted in the drawings.

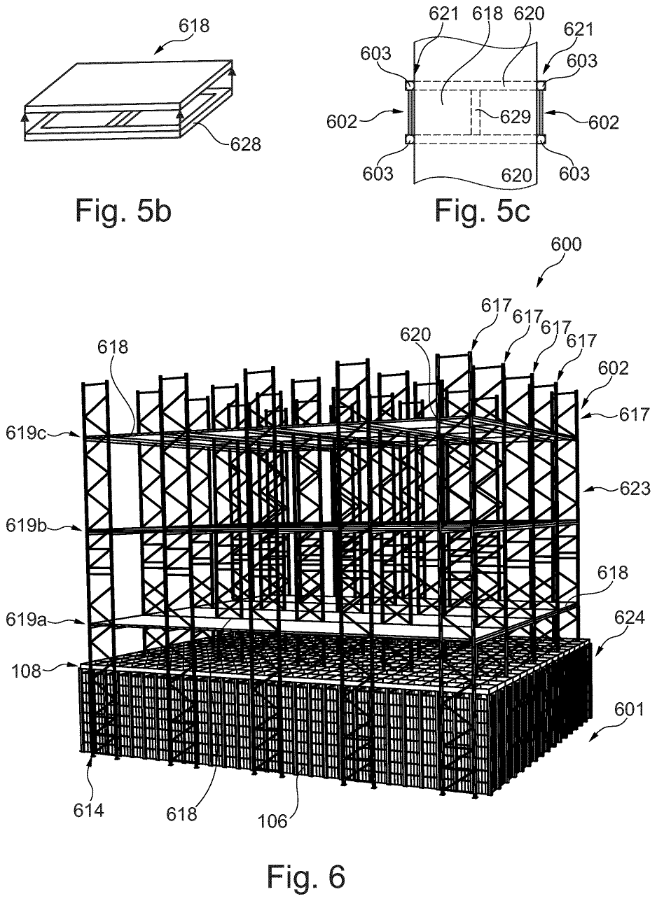

One embodiment of the multi-level storage system according to the disclosure will now be discussed in more detail with reference to FIGS. 5 to 10.

FIG. 5a shows a storage system 600 in the process of being assembled in a perspective view. The storage system 600 is created on a floor 601 of an industrial hall or a warehouse. A plurality of upright floor support components 602 is arranged on the floor 601. Exemplarily, they are each realized in the form of a two-dimensional or flat truss, i.e. a planar framework, having two elongate profile members 603 arranged at a distance to each other and connected by a plurality of diagonal struts 604 and perpendicular (e.g. horizontal) braces 605. However, other flat frameworks or other types of upright floor support components may be used.

The elongate members 603 of the upright floor support components 602 exemplarily comprise a C-profile, wherein the open sides face inwardly, i.e. to the respective other elongate member 603 of the same upright floor support component 602. In detail A, a possible configuration of an elongate member 603 is shown. Here, the open ends of the C-profiles each comprise two flanges 606, which are arranged parallel and at a distance to each other. The diagonal struts 604 and perpendicular braces 605 exemplarily extend through an intermediate space 607 between the two flanges 606 and are fastened to the elongate members 603 with bolts 608 reaching through fastening holes 609 arranged in side faces 610 of the elongate members 603 to engage corresponding nuts 611.

The elongate members 603 comprise connection members 612 in the form of window holes arranged on a front face 613 of the elongate members 603 opposite the open end of the C-profile. Here, support devices may be inserted.

The upright floor support components 602 may be pallet racking frames. They may be designed according to EN 15512 or another relevant standard. These pallet racking frames may be standard parts for pallet racking that usually allow palleted materials to be stored and accessed by forklift trucks.

A floor section 614 of the upright floor support component 602 exemplarily has two base plates 615, each of which is attached to one of the elongate members 603. The base plates 615 comprise holes 616 that allow to fixedly attach the upright floor support components 602 to the floor 601.

In the illustration, the upright floor support components 602 are exemplarily provided in five rows 617 of five upright floor support components 602 each. In each of the rows 617, the elongate members 603 of all upright floor support components 602 are in the same plane, and the upright floor support components 602 of each row 617 are placed in a distance to each other, preferably in an equidistant manner. The rows 617 are arranged at a distance to each other on the floor 601. As a result, a matrix-like arrangement of upright floor support components 603 is formed.

A plurality of floor panels 618 is provided, which are carried by the upright floor support components 603 to form intermediate floors 619a, 619b and 619c. The floor panels 618 rest on support beams 620, which are connected to the upright floor support components 603 through support devices 621. Preferably, they extend perpendicular between a pair of directly opposed main faces of two upright floor support components 603 of two neighboring rows. Exemplarily, the floor panels 618 are dimensioned to extend between two neighboring rows 617 from one end to an opposite end. If the arrangement of upright floor support components 603 has significantly larger dimensions than exemplarily shown in FIG. 5a, instead of a single floor panel 618 a plurality of floor panels 618 may be arranged in an end to end relationship between the neighboring rows 617. In the shown illustration, exemplarily four floor panels 618 are used for each intermediate floor 619a, 619b and 619c.

Each support device 621 is exemplarily provided in the form of an angular bracket, which has two plates 622 arranged at a right angle to each other, which allows it to be placed on one of the elongate profile members 603. Here, one of the plates 622 may engage some of the window holes 612 through complementary shaped hooks (not shown herein). By placing several support beams 620 on the upright members 602, floor panels 618 can be supported on the upright floor support components 602. Thereby, a support framework structure 623 is created.

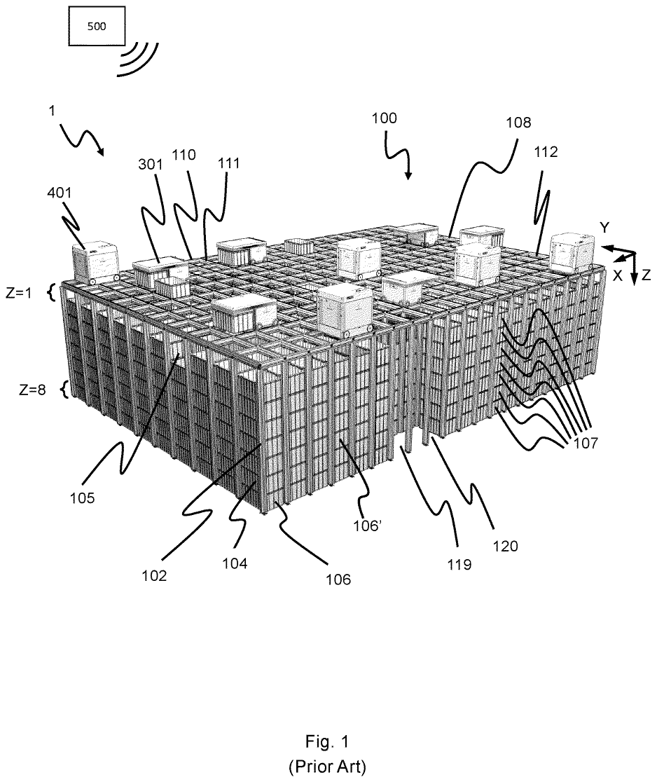

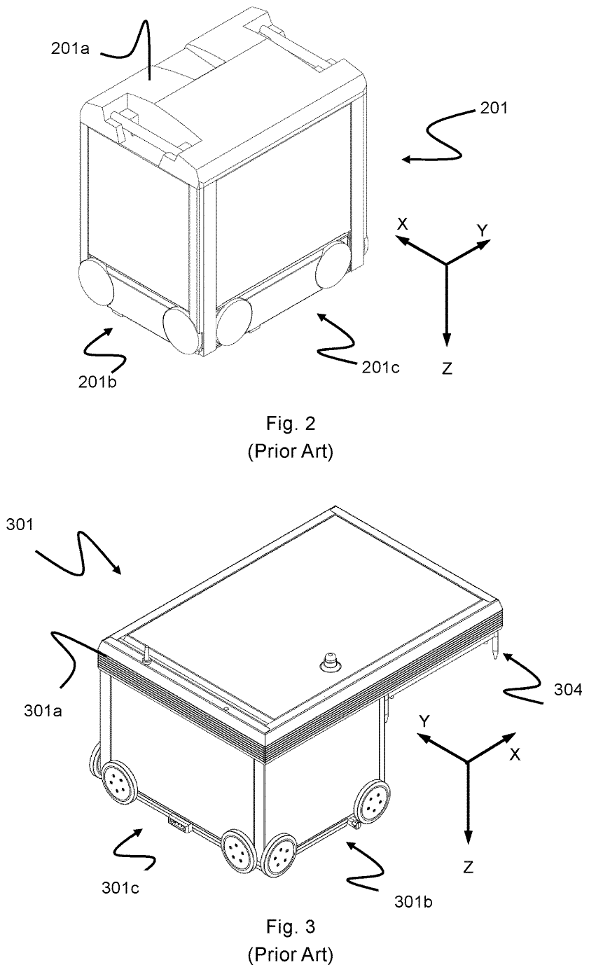

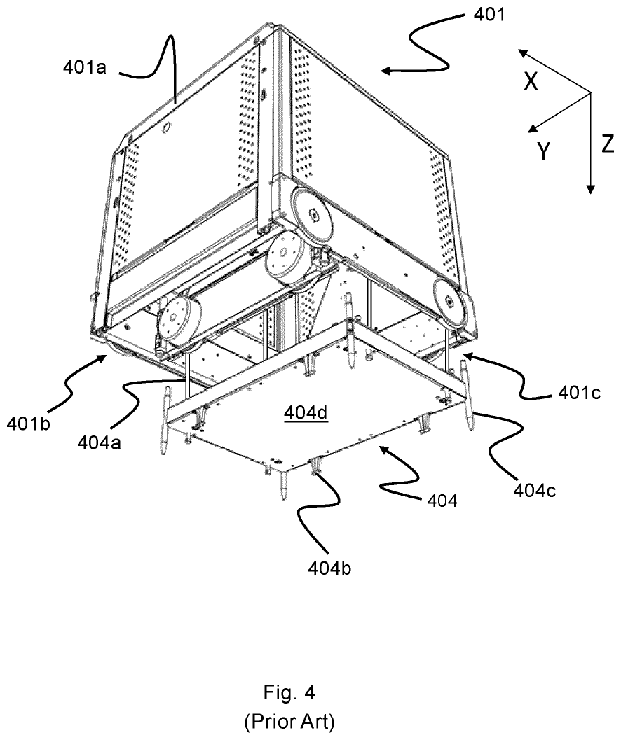

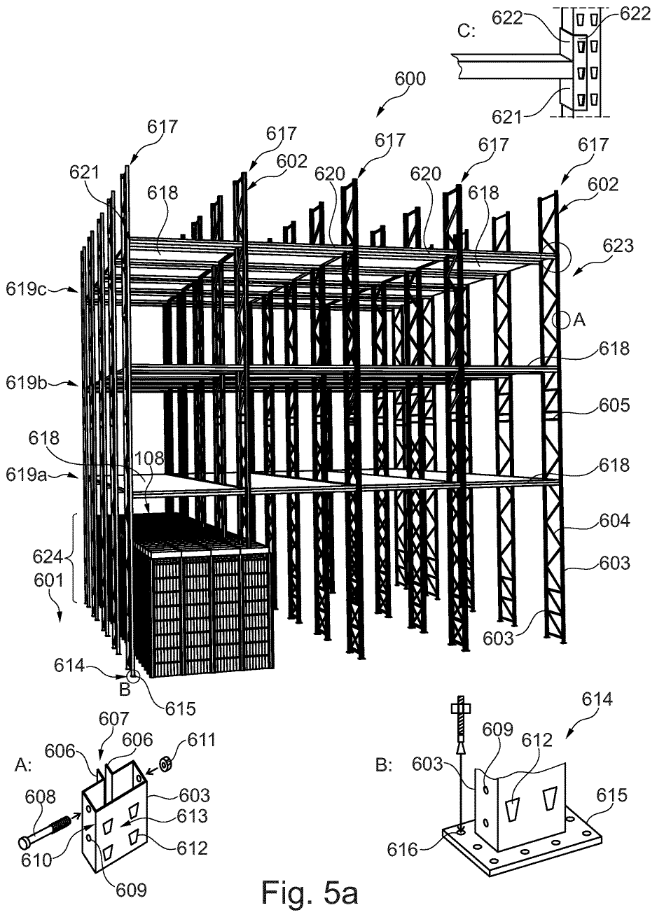

Beneath the lowermost intermediate floor 619a, a first grid structure 624 is created. The first grid structure 624 comprises a framework structure 100, which is constructed in a similar manner to the prior art framework structure 100 described above in connection with FIGS. 1-3. That is, the framework structure 100 comprises a number of upright members 102, and comprises a first, upper rail system 108 extending in the X direction and Y direction. The framework structure 100 further comprises storage compartments in the form of storage columns 105 provided between the upright members 102 wherein storage containers 106 are stackable in stacks 107 within the storage columns 105. The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

The upright floor support components 602 exemplarily extend through the first grid structure 624. The first intermediate floor 619a is arranged in a sufficient vertical distance to the rail system 108 of the first grid structure 624 to allow remotely operated vehicles to operate on the rail system of the first grid structure 624. If the upright floor support components 602 correspond to common pallet racking frames, the tolerable load for the connection devices 621 may be limited to e.g. 3 metric tons. A second grid structure, which can be placed on the intermediate floors 619a, 619b and 619c may thus have a slightly reduced height compared to the first grid structure 624 to not exceed the load onto the intermediate floors 619a, 619b and 619c.

FIG. 5b shows a floor panel 618, which exemplarily is formed by a particle board. Optionally, a stiffening structure 628, which may be made from a metal material, may be placed underneath the particle board to form a stiff floor panel 618.

FIG. 5c shows a part of a floor panel 618 in a top view, wherein long sides of the floor panel 618 are carried by two upright floor support components 603. Two parallel support beams 620 are shown with dashed lines, which support beams 620 carry the floor panel 618. A depth support strut 629 is attached to both support beams 620 and is exemplarily arranged perpendicularly to them.

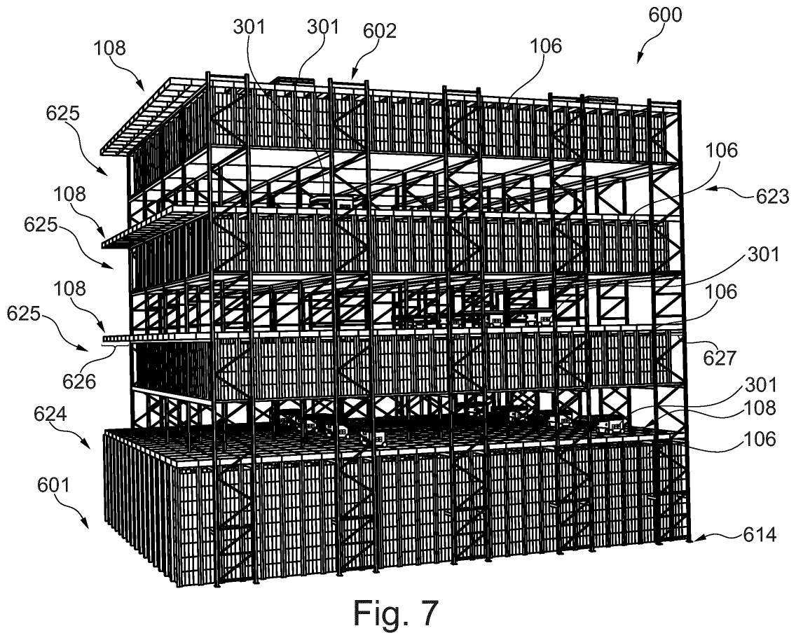

FIG. 6 shows the storage system 600 with a first grid structure 624 that is extended compared to the illustration in FIG. 5a. It comprises 16 rows of 28 columns, which are each capable of storing a stack of 8 storage containers 106. The three intermediate floors 619a, 619b and 619c can be set up to better utilize the height inside the industrial hall or warehouse, where the storage system 600 is installed.

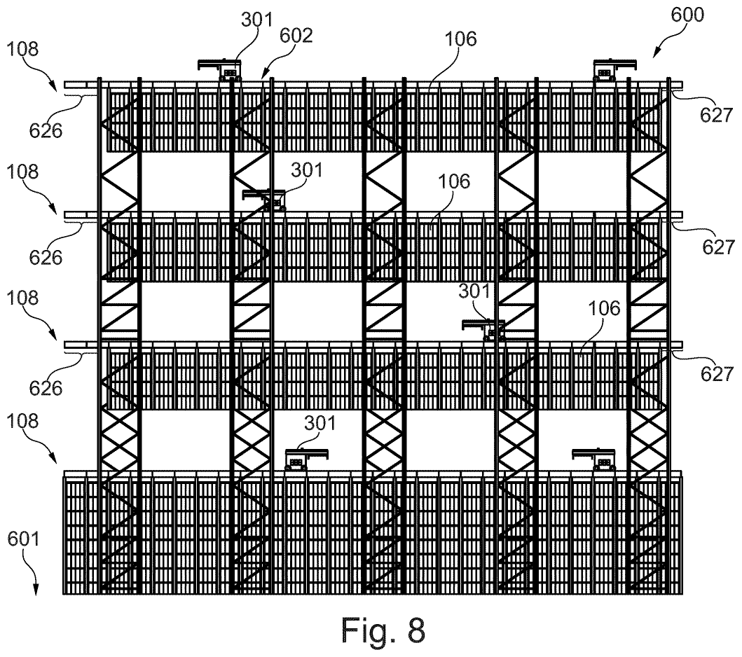

FIG. 7 shows the storage system 600 having three second grid structures 625, which substantially correspond to the first grid structure 624. Here, the second grid structures 625 comprise a size of 16 rows of 25 columns, each of which is capable of storing a stack of 4 storage containers 106. Hence, the second grid structure 625 has a footprint that is 3 columns smaller than the first grid structure 624. On the left-hand side in FIG. 7, the rail system 108 of the second grid structures 625 forms a delivery section 626 in form of an overhang and reaches beyond the first intermediate floor 619a over the first grid structure 624. Remotely operated vehicles 301 traveling on the rail system 108 of the lowermost second grid structure 625 may thus retrieve a storage container 106 and lower it onto the first grid structure 624 through the delivery section 626. Then, a remotely operated vehicle 301 of the first grid structure 624 may retrieve this storage container 106 and deliver it to a port or the like. On the right-hand side of FIG. 7, a further delivery section 627 is shown, which may allow to lower a storage container 106 through the overhang 627 to the first grid structure 624, too.

In analogy, this applies to the other second grid structures on the further intermediate floors 619b and 619c, too. Storage containers 106 may be lowered through all delivery sections 626 or 627 to the first grid structure 624.

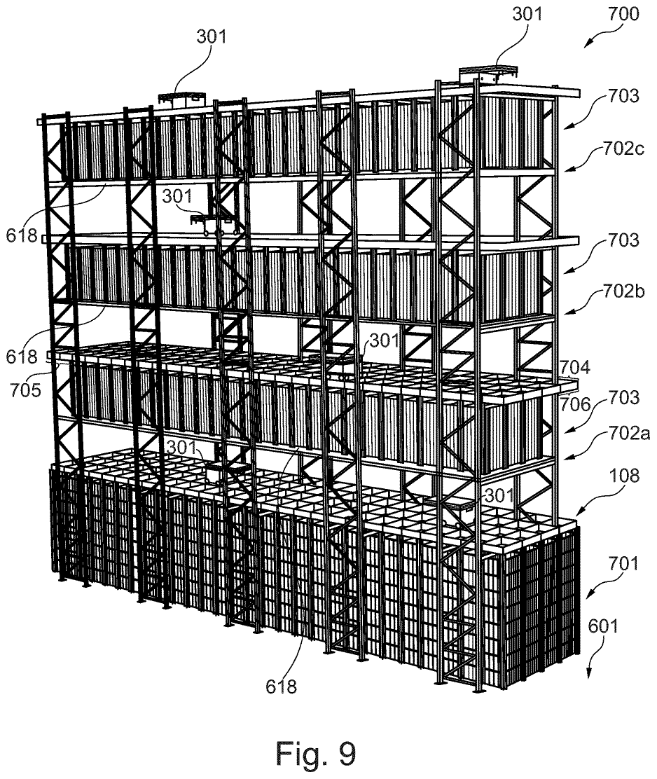

FIG. 8 shows a side view of the storage system 600, in which the delivery sections 626 and 627 as well as the differences in height of the grid structures are illustrated.

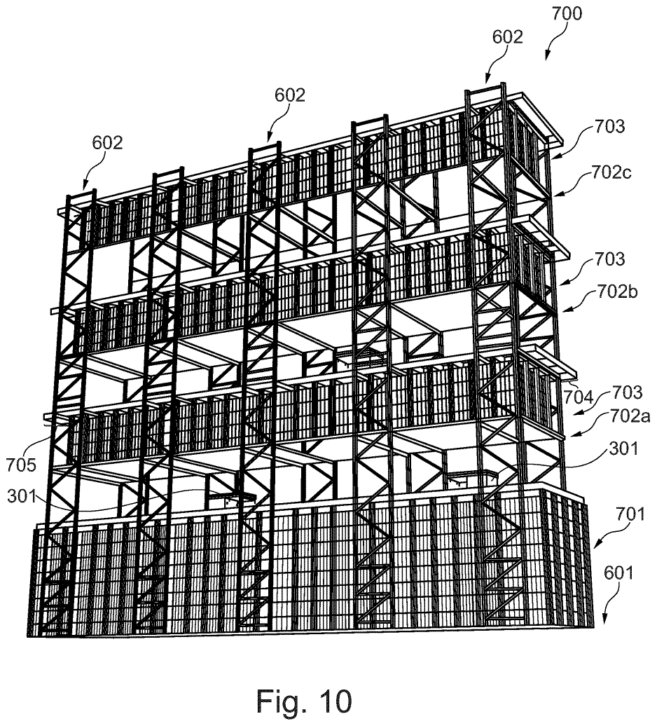

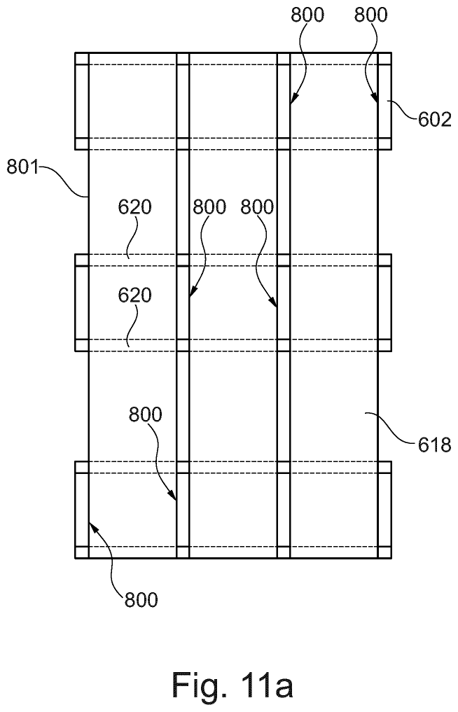

In FIGS. 9 and 10, a modified storage system 700 is shown, which is narrower than the storage system 600 of the previous figures. A first grid structure 701 has four rows of 28 columns, each of which is capable of storing a stack of 8 storage containers 106. Ten upright floor support components 602 in two rows carry three intermediate floors 702a, 702b, 702c. On these, two second grid structures 703 are placed, each having 3 rows of 25 columns, each of which is capable of storing four storage containers 106. Exemplarily, three delivery sections 704, 705 and 706 are provided on three sides of the second grid structures 703.

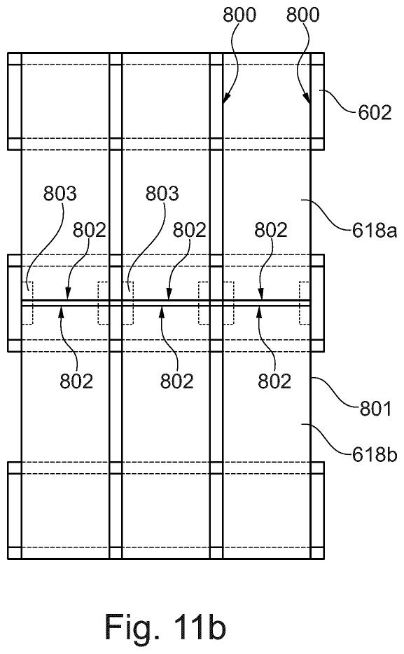

FIG. 11a shows floor panels 618 arranged between opposed main faces 800 of upright floor support components 602. Here, long sides 801 of the floor panels 618 are parallel to the main faces 800 and the floor panels 618 are parallel to the base floor 601. The floor panels 618 rest on several consecutive support beams 620 of consecutive pairs of upright floor support components 602.

FIG. 11b shows a modified embodiment, where the floor panels 618 are separated into two parts 618a and 618b that are arranged in an end-to-end manner. Short sides 802 of the floor panel parts 618a and 618b are connected to each other through clips 803, which may be attached to the respective floor panel parts 618a and 618b at an underside.

In the preceding description, various aspects of the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

Also disclosed herein are a number of clauses according to the following numbered paragraphs.
1. Multi-level storage system (600, 700), comprising:
a first grid structure (624, 701) of first storage columns, each first storage column being arranged to accommodate a stack of storage containers,
a second grid structure (625, 703) of second storage columns, each second storage column being arranged to accommodate a stack of storage containers (106),
a plurality of upright floor support components (602),
an intermediate floor (619) comprising a floor panel (618), and
a plurality of container handling vehicles (201, 301, 401) for handling storage containers (106),
wherein the first grid structure (624, 701) and the second grid structure (625, 703) each comprise an associated rail system (108) having a first set of parallel rails (110) arranged in a horizontal plane and extending in a first direction (X), and a second set of parallel rails (111) arranged in the horizontal plane and extending in a second direction (Y) which is orthogonal to the first direction (X), which first and second sets of rails (110, 111) form a grid pattern in the horizontal plane comprising a plurality of adjacent grid columns, each comprising a grid opening defined by a pair of neighboring rails (110) of the first set of rails (110) and a pair of neighboring rails (111) of the second set of rails (111),
wherein the storage columns of the first grid structure (624, 701) and second grid structure (625, 703) are arranged beneath the associated rail system (108), wherein a first plurality of container handling vehicles (201, 301, 401) are configured to move on the rail system (108) of the first grid structure (624, 701) and a second plurality of container handling vehicles are configured to move on the rail system (108) of the second grid structure (625, 703),
wherein the upright floor support components (602) and the floor panel are configured to form a support framework extending from a base floor with the intermediate floor arranged at a vertical distance from, the base floor by supporting the floor panel using the upright floor support components (602),
wherein the first grid structure (624, 701) is arranged beneath the intermediate floor (619) and wherein the second grid structure (625, 703) is arranged on the intermediate floor (619).
2. The storage system (600, 700) according to clause 1, wherein one or more of the upright floor support components (602) comprise a planar truss.
3. The storage system (600, 700) according to clause 1 or 2, wherein the upright floor support components (602) comprise a metal material.
4. The storage system (600, 700) according to any of the preceding clauses, wherein one or more of the upright floor support components (602) comprise a pallet racking frame.
5. The storage system (600, 700) according to any of the preceding clauses, comprising a plurality of support devices (621) attachable to the upright floor support components (602), wherein the floor panel (618) is couplable with the support devices (621).
6. The storage system (600, 700) according to clause 5, wherein the support device (621) comprises a support bracket.
7. The storage system (600, 700) according to clause 5 or 6, wherein the support device (621) comprises a support beam (620) configured to extend perpendicularly to the upright floor support component (602), to which the support device (621) is coupled.
8. The storage system (600, 700) according to clause 7 when dependent on claim 6, wherein the support beam (620) is rigidly attached to the support bracket.
9. The storage system (600, 700) according to any of the preceding clauses, wherein the floor panel (618) comprises a stiffening structure.
10. The storage system (600, 700) according to clause 9, comprising a depth support strut arranged beneath the floor panel (618) for supporting the floor panel (618).
11. The storage system (600, 700) according to any of the preceding clauses, wherein the upright floor support components (602) have a base plate configured to be anchored to the base floor (601).
12. The storage system (600, 700) according to any of the preceding clauses, wherein the second grid structure (625) has a smaller height than the first grid structure (624).
13. The storage system (600, 700) according to any of the preceding clauses, comprising a plurality of floor panels (618), wherein each floor panel (618) is coupled with at least one pair of upright floor support components (602).
14. The storage system (600, 700) according to clause 13, wherein adjacent floor panels (618) are connected to each other to avoid creation or enlargement of gaps between the floor panels (618).
15. The storage system (600, 700) according to clause 13 or 14,
wherein the floor panels (618) have a rectangular footprint with a pair of parallel long sides and a pair of parallel short sides, and
wherein at least the long sides of the floor panels (618) are coupled with the upright floor support component (602).
16. The storage system (600, 700) according to any of the preceding clauses,
wherein the rail system (108) of the second grid structure (625, 703) comprises a rail system extension that extends beyond the second storage columns and the intermediate floor (619) to form a delivery section (626, 627, 704, 705, 706), and
wherein the delivery section (626, 627, 704, 705, 706) is arranged vertically directly above the first grid structure (624, 701), such that container handling vehicles (201, 301, 401) on the rail system (108) of the second grid structure (625, 703) are capable of retrieving storage containers (106) from or lowering storage containers (106) into the first grid structure (624, 701).
17. The storage system (600, 700) according to clause 16, wherein the delivery section (626, 627, 704, 705, 706) extends along at least one side of the second grid structure (625, 703).
18. A method of creating a storage system of any of the clauses 1 to 17, the method comprising:
providing a first grid structure (624, 701) of first storage columns, each first storage column being arranged to accommodate a vertical stack of storage containers, on a ground,
arranging a plurality of upright floor support components (602) on the ground and coupling a floor panel (618) with the upright floor support components (602) in a selected vertical position on the upright floor support components (602) to form a support framework on the ground with an intermediate floor arranged in a vertical distance to the ground, and
providing a second grid structure (625, 703) of second storage columns, each second storage column being arranged to accommodate a vertical stack of storage containers (106), on the intermediate floor (619),
wherein the first grid structure (624, 701) and the second grid structure (625, 703) each comprise a rail system (108) having a first set of parallel rails (110) arranged in a horizontal plane and extending in a first direction (X), and a second set of parallel rails (111) arranged in the horizontal plane and extending in a second direction (Y) which is orthogonal to the first direction (X), which first and second sets of rails (110, 111) form a grid pattern in the horizontal plane comprising a plurality of adjacent grid columns, each comprising a grid opening defined by a pair of neighboring rails (110) of the first set of rails (110) and a pair of neighboring rails (111) of the second set of rails (111), the rail system (108) being configured to let remotely operated vehicle (201, 301, 401) operate on it.

LIST OF REFERENCE NUMBERS

| | |
|---|---|
| 1 | Prior art automated storage and retrieval system |
| 100 | Framework structure |
| 102 | Upright members of framework structure |
| 104 | Storage grid |
| 105 | Storage column |
| 106 | Storage container |
| 106′ | Particular position of storage container |
| 107 | Stack |
| 108 | Rail system |
| 110 | Parallel rails in first direction (X) |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels in first |
| | direction (X) |
| 201c | Drive means/wheel arrangement/second set of wheels in |
| | second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 304 | Gripping device |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 600 | Storage system |
| 601 | Base floor |
| 602 | Upright floor support component |
| 603 | Elongate member |
| 604 | Diagonal strut |
| 605 | Horizontal brace |
| 606 | Flange |
| 607 | Intermediate space |
| 608 | Bolt |
| 609 | Fastening hole |
| 610 | Side face |
| 611 | Nut |
| 612 | Connection member |
| 613 | Front face |
| 614 | Floor section |
| 615 | Base plate |
| 616 | Hole |
| 617 | Row |
| 618 | Floor panel |
| 619 | Intermediate floor (619a, 619b and 619c) |
| 620 | Support beam |
| 621 | Support device |
| 622 | Plate |
| 623 | Support framework structure |
| 624 | First grid structure |
| 625 | Second grid structure |
| 626 | Delivery section |
| 627 | Delivery section |
| 628 | Stiffening structure |
| 700 | Storage system |
| 701 | First grid structure |
| 702 | Intermediate floor |
| 703 | Second grid structure |
| 704 | Delivery section |
| 705 | Delivery section |
| 706 | Longitudinal overhang |
| 800 | Main face |
| 801 | Long side |
| 802 | Short side |
| 803 | Clip |
| X | First direction |
| Y | Second direction |
| Z | Third direction |

1.-15. (canceled)

16. Multi-level storage system, comprising:
a first grid structure of first storage columns, each first storage column being arranged to accommodate a stack of storage containers,
a second grid structure of second storage columns, each second storage column being arranged to accommodate a stack of storage containers,
a plurality of upright floor support components, and
an intermediate floor,
wherein each of the first grid structure and the second grid structure comprises an associated rail system, wherein each associated rail system is configured to receive a respective container handling vehicle thereon,
wherein the storage columns of the first grid structure and second grid structure are arranged beneath their associated rail system,
wherein the upright floor support components are configured to form a support framework extending from a base floor, with the intermediate floor arranged at a vertical distance from the base floor,
wherein the first grid structure is arranged beneath the intermediate floor, and wherein the second grid structure is arranged on the intermediate floor.

17. The multi-level storage system according to claim 16, wherein the intermediate floor comprises a floor panel, and wherein the upright floor support components and the floor panel are configured to form a support framework extending from a base floor, with the intermediate floor arranged at a vertical distance from the base floor by supporting the floor panel using the upright floor support components.

18. The multi-level storage system according to claim 16, wherein each associated rail system has a first set of parallel rails arranged in a horizontal plane and extending in a first direction (X), and a second set of parallel rails arranged in the horizontal plane and extending in a second direction (Y) which is orthogonal to the first direction (X), which first and second sets of rails form a grid pattern in the horizontal plane comprising a plurality of adjacent grid columns, each comprising a grid opening defined by a pair of neighboring rails of the first set of rails and a pair of neighboring rails of the second set of rails.

19. The multi-level storage system according to claim 16, further comprising a plurality of container handling vehicles for handling storage containers, wherein each container handling vehicle of a first plurality of container handling vehicles is configured to move on the rail system of the first grid structure and each container handling vehicle of a second plurality of container handling vehicles is configured to move on the rail system of the second grid structure.

20. The multi-level storage system according to claim 16, wherein one or more of the upright floor support components comprise a planar truss.

21. The multi-level storage system according to claim 16, wherein the upright floor support components comprise a metal material.

22. The multi-level storage system according to claim 16, wherein one or more of the upright floor support components comprise a pallet racking frame.

23. The multi-level storage system according to claim 16, comprising a plurality of support devices attachable to the upright floor support components.

24. The multi-level storage system according to claim 20, wherein the support device comprises a support bracket.

25. The multi-level storage system according to claim 20, wherein the support device comprises a support beam configured to extend perpendicularly to the upright floor support component, to which the support device is coupled, optionally wherein the support beam is rigidly attached to the support bracket.

26. The multi-level storage system according to claim 16, wherein the upright floor support components have a base plate configured to be anchored to the base floor.

27. The multi-level storage system according to claim 16, wherein the second grid structure has a smaller height than the first grid structure.

28. The multi-level storage system according to claim 16,
wherein the rail system of the second grid structure comprises a rail system extension that extends beyond the second storage columns and the intermediate floor to form a delivery section, and
wherein the delivery section is arranged vertically directly above the first grid structure, such that container handling vehicles on the rail system of the second grid structure are capable of retrieving storage containers from or lowering storage containers into the first grid structure.

29. The multi-level storage system according to claim 28, wherein the delivery section extends along at least one side of the second grid structure.

30. A method of creating a multi-level storage system according to claim 16, the method comprising:
providing a first grid structure of first storage columns, each first storage column being arranged to accommodate a vertical stack of storage containers, on a ground,
arranging a plurality of upright floor support components on the ground and coupling a floor panel with the upright floor support components in a selected vertical position on the upright floor support components to form a support framework on the ground with an intermediate floor arranged at a vertical distance from the ground, and
providing a second grid structure of second storage columns, each second storage column being arranged to accommodate a vertical stack of storage containers, on the intermediate floor.
